(19) United States
(12) Patent Application Publication
(10) Pub. No.: US 2016/0337303 A1
(43) Pub. Date: Nov. 17, 2016

(54) METHOD AND SYSTEM FOR APPROVING OR DISAPPROVING CONNECTION REQUESTS

(71) Applicant: Sony Mobile Communications Inc., Tokyo (JP)

(72) Inventors: Anders ISBERG, Akarp (SE); Håkan JONSSON, Hjarup (SE)

(21) Appl. No.: 14/712,601

(22) Filed: May 14, 2015

(51) Int. Cl. H04L 12/58; H04L 29/06; H04W 8/20; H04W 4/00

(52) U.S. Cl. CPC H04L 51/32; H04W 4/001; H04L 63/20; H04W 8/20

(57) ABSTRACT

The present invention relates to the field of method and systems for approving or disapproving connection requests between devices. The present invention discloses a method for approving or disapproving a connection request between a first device and a second device, which method comprises sending, by the first device, a connection request to the second device, the connection request comprising an unique identifier of the first device, receiving, at the second device, the connection request from the first device, retrieving, by the second device, account information connected to the unique identifier of the first device from a database, determining, based on the account information, an amount of interconnectivity between the first device and the second device, approving the connection request if the amount of interconnectivity reaches a threshold amount of interconnectivity; and disapproving the connection request if the amount of interconnectivity does not reach the threshold amount of interconnectivity.

### TECHNICAL FIELD

The present disclosure generally relates to the field of method and systems for approving or disapproving connection requests between electronic devices.

### BACKGROUND OF THE INVENTION

The world is becoming ever more connected with devices being connected in both wired and wireless networks. Currently, connection requests between two electronic devices, for example connecting a phone to another phone, or a car using Bluetooth or WiFi are handled based on the identity of the devices. For example, a first device may send a connection request for access to content or a service from a second device. This results in a user of the second device being prompted to approve or disapprove the connection request. Typically, such a prompt only contain information about the device, such as the device name, but nothing else. Based on this information the user has to make a decision whether to trust the device or not and approve or disapprove the connection request. The device name may be standardized at the time of manufacture and the same for all devices, e.g. “Xperia Z1”, unless its owner has changed it via e.g. a configuration or settings menu. However, as readily appreciated even if a user has changed the device name, only the device name does not provide another user with a sufficient basis to guarantee that the device is to be trusted and the connection request approved. Hence, the current regime for performing approving or disapproving connection request, e.g. device interaction such as pairing of two devices, is both tedious and time consuming for the users and it is almost impossible to know whether a device trying to connect it to be trusted or not. Further, erroneously approving a connection request may have serious security risks. For example, a device may change owner, which means that access would be given although the device, and the user thereof, should no longer be trusted.

### SUMMARY OF THE INVENTION

In view of the above, an objective of the invention is to solve or at least reduce one or several of the drawbacks discussed above. Generally, the above objective is achieved by the attached independent patent claims.

According to a first aspect of the present invention, this and other objectives are achieved by a method for approving or disapproving a connection request between a first device and a second device. The method comprises the steps of sending, by the first device, a connection request to the second device, the connection request comprising a unique identifier of the first device, and receiving, at the second device, the connection request from the first device. The method further comprises the steps of retrieving, by the second device, account information connected to the unique identifier of the first device from a database, and determining, based on the account information, an amount of interconnectivity between the first device and the second device. The method further comprises the steps of approving the connection request if the amount of interconnectivity reaches a threshold amount of interconnectivity, and/or disapproving the connection request if the amount of interconnectivity does not reach the threshold amount of interconnectivity.

The present invention is based on the realization that a connection request can automatically be approved or disapproved based on a threshold amount of interconnectivity between a first device and a second device. Hence, the present invention provides an automatic method for approving or disapproving a connection request based on the amount of interconnectivity, thereby both saving time for the users and reducing the risks for erroneously approving connection requests. The connection request may be approved or disapproved based on whether the amount of interconnectivity reaches a threshold amount of interconnectivity. In other words, the threshold amount of interconnectivity may be used to define a trusted list, e.g. a white list, of devices which reach the threshold amount of interconnectivity and therefore are allowed to connect with the second device. The account information in the database may be continuously updated, which means that a device which was trusted at an earlier connection request need not be automatically approved the next time a connection request is attempted. An additional advantage is that the present invention is also appropriate to use for devices that only have intermittent connectivity, e.g. devices which only sends or receives information once an hour, once a day or the like. An additional advantage is that the present invention solves or at least reduces the drawbacks discussed above without modifying existing communication protocols, but through adding a simple layer of device interaction and communication to establish an amount of interconnectivity.

The unique identifier may comprise at least one of: MAC address, IMEI, IMSI, ICC ID, IP address, telephone number.

In one embodiment of the invention, the step of disapproving may further comprise prompting a user of the second device to manually approve or disapprove the connection request.

The account information may comprise information about a current user of the first device. The account information may comprise information about a current user of the first device from a plurality of users of the first device. The account information may comprise information about accounts connected to a current user or one of the plurality of user of the first device, particularly at least one of: social media accounts, telephone contacts, email contacts, and organizational affiliation.

The threshold amount of interconnectivity may be at least one of: a contact in the social media accounts, a telephone contact, an email address, a trusted organizational affiliation, a contact in the social media accounts to one of the plurality of users, a common contact in the social media accounts to one of the plurality of users, a telephone contact to one of the plurality of users, an email-address to one of the plurality of users. The threshold amount of interconnectivity may be set by a user of the second device.

The method may further comprise a step of retrieving, by the second device, policy information from a policy manager unit, wherein the policy information is used to set the threshold amount of interconnectivity.

The policy information may further comprise information relating to whether to approve or disapprove the connection request based on at least one of: a current time, a location, and an organizational affiliation.

The policy manager unit may be configured to push the policy information to the second device.

According to a second aspect of the present invention, the objectives are also at least partly achieved by a system for approving or disapproving a connection request. The system comprises a first device having a unique identifier, and communication means, a database storing account information connected to the unique identifier of the first device, and a second device having a processor and communication means. The second device is configured to receive a connection request comprising the unique identifier from the first device via the communication means, and the second device is further configured to retrieve the account information from the database, and determine, by using the processor, based on the account information an amount of interconnectivity between the first device and the second device. The second device is further configured to approve the connection request if the amount of interconnectivity reaches a threshold amount of interconnectivity or disapprove the connection request if the amount of interconnectivity does not reach a threshold amount of interconnectivity.

The second aspect may generally have the same features and advantages as the first aspect. The system may further comprise a policy manager unit having policy information for the second device, and the policy information may be used to set the threshold amount of interconnectivity. The policy manager may be arranged remotely, e.g. at a server, cloud service or locally on the second device.

The communication means for the first and second device may be either a wireless or wired electronic communication. The communication means for the first and second device may be different.

The policy manager unit and/or the database may be located in a remote server or cloud service. Alternatively, the policy manager unit may be arranged in the second device.

### BRIEF DESCRIPTION OF THE DRAWINGS

The above, as well as additional objects, features and advantages of the present invention, will be better understood through the following illustrative and non-limiting detailed description of embodiments of the present invention, with reference to the appended drawings, where the same reference numerals will be used for similar elements, wherein:

FIG. 1 shows a system for approving or disapproving connection requests according to embodiments of the invention,

FIG. 2 shows a flow chart for a method for approving or disapproving connection requests according to various embodiments of the invention,

FIG. 3 schematically shows a message sequence chart outlining information and where the information is sent in the system according to various embodiments of the invention,

### DETAILED DESCRIPTION OF EMBODIMENTS

In the present detailed description, embodiments of a method and system according to the present invention are mainly discussed with reference to schematic views showing a system, a flow chart, and a message sequence chart according to various embodiments of the invention. It should be noted that this by no means limits the scope of the invention, which is also applicable in other circumstances for instance with other types or variants of systems or devices than the embodiments shown in the appended drawings. Further, that specific components are mentioned in connection to an embodiment of the invention does not mean that those components cannot be used to an advantage together with other embodiments of the invention. The invention will now be described with reference to the enclosed drawings where first attention will be drawn to the structure, and secondly to the function.

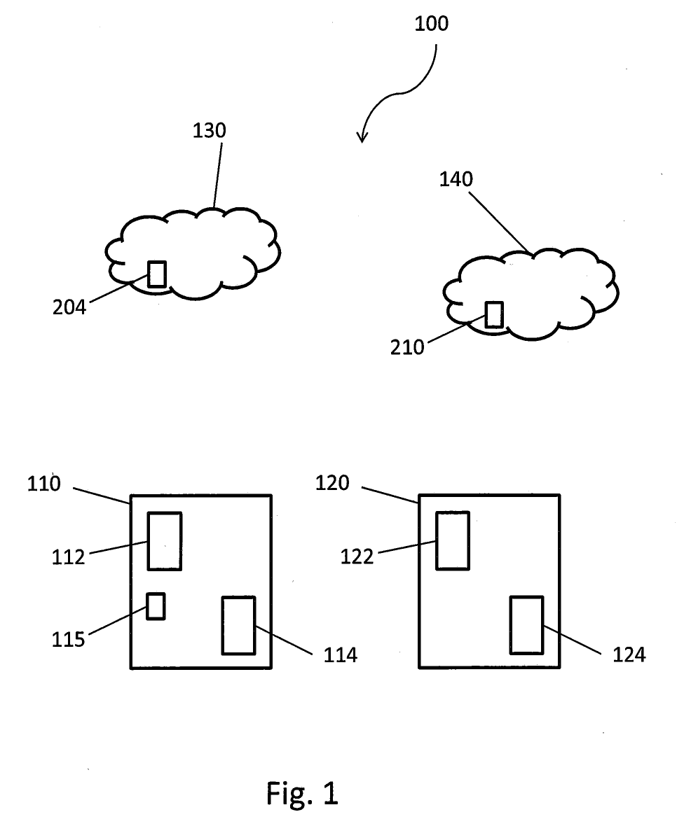

FIG. 1 shows a system 100 for approving or disapproving a connection request according to one embodiment of the invention. The system 100 comprises first device 110, a second device 120, a database 130 and a policy manager unit 140.

The first and second device 110, 120 may be any kind of electronic device generally used for device interaction or pairing, such as telephone, tablet, appliance, TV, car, car entertainment system, smart watch, etc. The first device 110 comprises communication means 112, and the second device comprises communication means 122. The communication means 112, 122 mentioned herein are generally understood to be wireless communication means using electromagnetic waves such a cellular networks, Bluetooth, WiFi, Zigbee or the like. The communication means 112, 122 may thus comprise components such as antennas, transceiver circuitry, amplifiers, filters and so on for sending and receiving electromagnetic waves. As an alternative, the communication means 112, 122 can be configured to receive optical communications or audio communication. Alternatively, one or both of communication means 112, 122 and thereby the first and/or second device 110, 120 may be connected via a wired connection, e.g. a landline, Ethernet or the like. In order to perform computations and carry out instructions received via hardware, e.g. communications means 112, 122 or software from a machine-readable memory (not shown) the first and second device 110, 120 each comprises a processor 114, 124. While the communication means 112, 122 are typically implemented in hardware; at least some portions of the processors 114, 124 may typically be embodied by software modules. The present invention is not restricted to any particular realization, and any implementation found suitable to realize the herein described functionality may be contemplated. The first and second device 110, 120 may of course comprise additional components such as the aforementioned machine-readable memory, both volatile and non-volatile, means for displaying information or media, e.g. a screen, and means for inputting information, such as a keyboard, a keypad, a directional pad, a mouse, a pen, a touch-screen and/or biometric mechanisms etc. The first and second device 110, 120 may be configured to send information to update the account information in the database 130 whenever a user of the first or second device 110, 120 changes. The database 130 may be a remote server which comprises account information 204 connected to a unique identifier 115 of the first device 110. The database 140 may be implemented using cloud computing. The unique identifier 115 connected to the first device 110 may be at least one of a MAC address, IMEI, IMSI, ICC ID, IP address, telephone number. Hence, the first device 110 and possibly a user thereof may be uniquely identified by the account information 204 which connects one of the mentioned unique identifiers to a user of the first device 110. Thus, in one embodiment of the invention, the account information 204 connected to the unique identifier 115 comprises information about a current user of the first device 110. In another embodiment, the account information 204 connected to the unique identifier 115 comprises information about a current user of the first device 110 from a plurality of users of the first device 110. Hence, the account information 204 may either comprise information about one user, or one user from amongst a plurality of users. The account information 204 in the database 130 may comprise information about accounts connected to a current user or one of the plurality of users of the first device 110, particularly at least one of social media accounts, telephone contacts, email contacts, and organizational affiliation. The social media account may be any social media account such as a Facebook-account, a Linkedin-account, a Twitter-account, a Truecaller-account, etc. The account information 204 in the database 130 is therefore at least updated by the first device 110 when the current, e.g. active, user of the first device 110 changes, or when a user is no longer registered as a user of the first device 110.

The policy manager unit 140 may be a remote server which comprises policy information 210 for the second device 120. The policy manager 140 may be implemented using cloud computing, e.g. a cloud service. The policy information 210 may be used to set the threshold amount of interconnectivity between the first and second device 110, 120. It should be noted that different users of the second device 120 may have different threshold amounts of interconnectivity. It should be noted that a user of the second device 120 may have a higher priority than other users, such as being an administrator of the second device 120 and thereby being able to set the threshold amount of interconnectivity for all users of the second device 120. In a corporate or enterprise environment, new policy information 210 regarding what devices and users are to be trusted may need to be pushed out to all devices belonging to a corporation or organization. Therefore, in some embodiments the policy manager unit 140 may be configured to push the policy information 210 to the second device 120. In various embodiments, the policy manager unit 140 may be arranged in the second device 120 in order to allow a user of the second device to directly set the policy information 210 and thereby the threshold amount of interconnectivity.

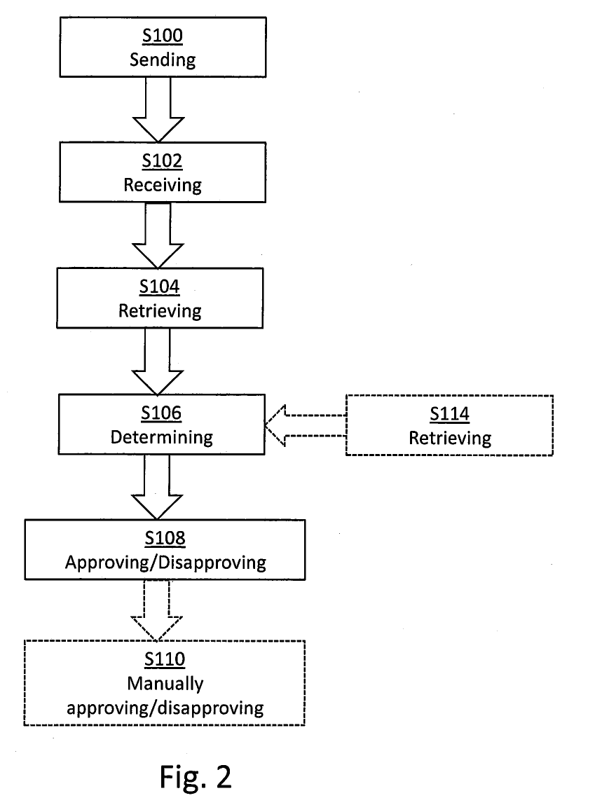

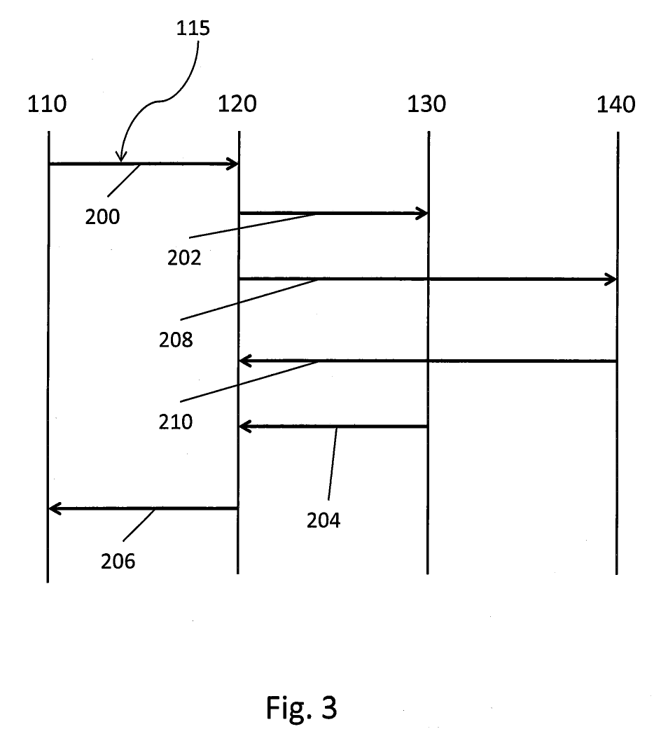

FIG. 2 shows a flow chart outlining the steps of a method according to embodiments of the present invention. FIG. 3 shows a message sequence chart showing the information being sent between the first device 110, the second device 120, the database 130, and the policy manager unit 140. Embodiments of the present disclosure will now be described in conjunction with FIG. 2 and FIG. 3.

The first step S100 comprises sending a connection request 200, by the first device 110, to the second device 120. The connection request 200 may be sent automatically. For example, the first device 110 may detect the possibility to connect with the second device 120 due to e.g. moving into range of a wireless network, e.g. a Bluetooth or Wifi network, offered by the second device 120. Alternatively the connection request 200 may be sent manually by a user of the first device 110 inputting instructions to connect to a network and requesting services or content of the second device 120. The connection request 200 being sent, by the first device 110, comprises the unique identifier 115 of the first device 110.

In the next step S102 the connection request 200 is received at the second device 120 from the first device 110.

In the next step S104, the second device 120, retrieves the account information 204 connected to the unique identifier 115 of the first device 110 from the database 130. The step of retrieving account information comprises sending a request for account information 202, by the second device 120, to the database 130 and receiving the account information 204 from the database 130. The request for account information 202 may comprise the unique identifier 115 Of the first device 110.

The next step S106 comprises determining, by the second device 120, an amount of interconnectivity between the first device 110 and the second device 120 based on the account information 204. The account information 204 as described above comprises information about a current user, or one user from a plurality of users of the first device 110, and in particular information regarding at least one of social media accounts, telephone contacts, email contacts, an email account of the user of the first device 110, phone number of a user of the first device 110, and organizational affiliation for the current user or one of the plurality of users. The second device 120 determines the amount of interconnectivity between the first and second device 110, 120 based on this information. Hence, the second device 120 may also use similar information connected to the second device 120 to determine the amount of interconnectivity. As an example the second device 120 may use account information connected to a current user of the second device 120 or one of a plurality of users connected to the second device 120. The amount of interconnectivity between the first and second device 110, 120 may then be determined based on the number of common; contacts in social media accounts, telephone contacts, email addresses, organizational affiliations. The amount of interconnectivity between the first and second device 110, 120 may also be determined based on a white list present in the second device 120, e.g. a list of allowed phone numbers, email accounts etc.

The next step S108 comprises approving or disapproving the connection request 200, e.g. allowing the first device 110 access to services or content on the second device 120, if the amount of interconnectivity reaches a threshold amount of interconnectivity. Approving the connection request 200, may comprise sending authorization 206 to the first device 110. If the connection request is disapproved, the authorization 206 may not be sent, or alternatively comprise information to the user of the first device 110 that access is denied. The threshold amount of interconnectivity may be set to at least one of: a contact in the social media accounts, a telephone contact, an email address, a trusted organizational affiliation, a contact in the social media accounts to one of the plurality of users, a common contact in the social media accounts to one of the plurality of users, a telephone contact to one of the plurality of users, an email-address to one of the plurality of users. Hence, it should be understood that there are several different possibilities to reach the threshold amount of interconnectivity.

As a first example, a user of the first device 110 may have enough common contacts, from the examples given above, with the user of the second device 120 for the threshold amount to be reached. As a second example, the threshold amount of interconnectivity may be reached by another user, i.e. one of the plurality of users of the first device 110, having enough common contacts with the user of the second device for the threshold amount of interconnectivity to be reached. As a third example, a combination of the two previous examples are also possible, that the common contacts of the current user of the first device 110 and the common contacts of One or more of the plurality of users of the first device 110 combined, reaches the threshold amount of interconnectivity. Hence, the threshold amount of interconnectivity may be set to more than one of the above mentioned examples. For example, at least two or more, or three or more, or five or more, or ten or more of the above mentioned examples. Thereby, it should be understood that it may also be required that different types of interconnectivity may be required to reach the threshold, or be combined to reach the threshold, such as a telephone contact and a common social media contact.

Hence, it should be understood that if the first device 110 has a plurality of users, the first device 110 may be trusted based on one of the users, which may not necessarily be the current user. The threshold amount of interconnectivity may be set by a user of the second device 120 through configuring the second device 120.

In some embodiments the method may comprise a further additional step S110, outlined in FIG. 2 by the dashed lines. The additional step S110 comprises prompting a user of the second device 120 to manually approve or disapprove the connection request 200. Thereby, a user of the second device 120 may override the threshold amount of interconnectivity, if the user knows and trusts the first device 110.

According to some embodiments, the method may comprise a step S114 of retrieving policy information 210 from the policy manager unit 140. The step comprises sending a request 208 to the policy manager unit 140 for the policy information 210, and receiving the policy information 210. The policy information 210 is used to set the threshold amount of interconnectivity. The policy information 210 may also comprise information relating to whether to approve or disapprove the connection request based on at least one of: a current time, a location, and an organizational affiliation. According to one example, the policy information 210 can instruct the second device 120 to approve all connection requests from a first device 110 which belongs to the same organizational affiliation. According to another example, the policy information 210 may geographically restrict the approval or disapproval of the connection request based on whether the second device 120 is located in an area or building. Such an area may e.g. be the company address of the organizational affiliation, a home address, an address to family or friends of a current user of the second device 120. The geographical location may be determined using the Global Positioning System (GPS), triangulation in a cellular network or similar methods. The policy information 210 may also set disapprove all connection request outside of office hours. It should be noted that combination and permutations of the above given examples are of course also possible and within the scope of the invention.

The policy manager unit 140 may also be configured to push the policy information 210 to the second device 120. Thereby, a company or organization may push policy information 210 to all devices belonging to the organization in order to exclude stolen devices or update the time, areas, or which organization are to be trusted by each device.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps. Additionally, even though the invention has been described with reference to specific exemplifying embodiments thereof, many different alterations, modifications and the like will become apparent for those skilled in the art. Variations to the disclosed embodiments can be understood and effected by the skilled addressee in practicing the claimed invention, from a study of the drawings, the disclosure, and the appended claims. furthermore, in the claims, the word “comprising” does not exclude other elements or steps, and the indefinite article “a” or “an” does not exclude a plurality.

1. A method for approving or disapproving a connection request between a first device and a second device, the method comprises the steps of:
sending, by the first device, a connection request to the second device, the connection request comprising an unique identifier of the first device;
receiving, at the second device, the connection request from the first device;
retrieving, by the second device, account information connected to the unique identifier of the first device from a database;
determining, based on the account information, an amount of interconnectivity between the first device and the second device;
approving the connection request if the amount of interconnectivity reaches a threshold amount of interconnectivity; and/or
disapproving the connection request if the amount of interconnectivity does not reach the threshold amount of interconnectivity.

2. The method according to claim 1, wherein the unique identifier comprises at least one of: MAC address, IMEI, IMSI, ICC ID, IP address, telephone number.

3. The method according to claim 1, wherein the step of disapproving further comprises prompting a user of the second device to manually approve or disapprove the connection request.

4. The method according to claim 1, wherein the account information comprises information about a current user of the first device.

5. The method according to claim 4, wherein the account information comprises information about a current user of the first device from a plurality of users of the first device.

6. The method according to claim 5, wherein the account information comprises information about accounts connected to a current user or one of the plurality of user of the first device, particularly at least one of: social media accounts, telephone contacts, email contacts, and organizational affiliation.

7. The method according to claim 6, wherein the threshold amount of interconnectivity is at least one of: a contact in the social media accounts, a telephone contact, an email address, a trusted organizational affiliation, a contact in the social media accounts to one of the plurality of users, a common contact in the social media accounts to one of the plurality of users, a telephone contact to one of the plurality of users, an email-address to one of the plurality of users.

8. The method according to claim 1, further comprising the step of:
retrieving, by the second device, policy information from a policy manager unit, wherein the policy information is used to set the threshold amount of interconnectivity.

9. The method according to claim 8, wherein the policy information further comprises information relating to whether to approve or disapprove the connection request based on at least one of: a current time, a location, and an organizational affiliation.

10. The method according to claim 8, wherein the policy manager unit pushes the policy information to the second device.

11. A system for approving or disapproving a connection request, the system comprising:
a first device having an unique identifier, and communication means;
a database storing account information connected to the unique identifier of the first device;
a second device having a processor and communication means;
wherein the second device is configured to receive a connection request comprising the unique identifier from the first device via the communication means, and
the second device is further configured to retrieve the account information from the database, and determine, by using the processor, based on the account information an amount of interconnectivity between the first device and the second device, and
approve the connection request if the amount of interconnectivity reaches a threshold amount of interconnectivity or disapprove the connection request if the amount of interconnectivity does not reach a threshold amount of interconnectivity.

12. The system according to claim 11, wherein the system further comprises a policy manager unit having policy information for the second device, wherein the policy information is used to set the threshold amount of interconnectivity.

13. The system according to claim 11, wherein the communication means for the first and second device is either a wireless or wired electronic communication.

14. The system according to claim 11, wherein the policy manager unit and/or the database are located in a remote server.
